(19) United States
(12) Patent Application Publication
(10) Pub. No.: US 2006/0080393 A1
(43) Pub. Date: Apr. 13, 2006

(54) Method for using e-mail documents to create and update address lists

(76) Inventors: Richard J. Cardone, Mahopac, NY (US); Norman H. Cohen, Suffern, NY (US); Danny Soroker, Larchmont, NY (US)

Correspondence Address: DILWORTH & BARRESE, LLP, 333 EARLE OVINGTON BLVD., UNIONDALE, NY, 11553, US

(21) Appl. No.: 10/963,347

(22) Filed: Oct. 12, 2004

(51) Int. Cl. G06F 15/16

(52) U.S. Cl. 709/206

(57) ABSTRACT

A method for generating address lists from documents, which include e-mail address, stored on a computing device is provided. The method describes mapping at least one e-mail address from the documents to the address list. The mapped address list may be updated by its inclusion as one of the input documents. Duplicate entries can be excluded from the address list and an addressee identifier can be assigning to each e-mail addresses in the mapped address list, by using a mapping table, an address book, or a user assignment. Any user-specified organization of addresses existing in the input documents can be preserved in the mapped address list. The mapping of the e-mail addresses can be performed by applying one or more set-theoretic operations selected from one of union, intersection, and difference.

### BACKGROUND OF THE INVENTION

1. Field of the Invention

The present invention relates to personal electronic communication, such as e-mail and instant messaging, and more specifically to using e-mail address information to create or update various types of address lists to be used as input into other computing processes.

2. Description of the Related Art

Current approaches to e-mail address list management only use the e-mail senders' address information. These approaches do not use the e-mail recipient's address information. Also, current approaches are limited in that they do not use the address data of e-mail documents to create different types of address lists, such as mailing lists, access-control lists and buddy lists used by instant messaging systems, such as AOL Instant Messenger (AIM™). Some of the above-mentioned approaches will be discussed below.

U.S. patent application Publication No. 20030191806A1, entitled “Hierarchical Org-Chart Based Email Mailing List Maintenance”, describes providing a capability by which changes in an organization can be automatically reflected in the organization's mailing lists and permissions that control access to those mailing lists. Here, information from organization charts is used to automatically generate mailing lists and to assign permission that allows access to those mailing lists. This application discloses an ability to update existing mailing lists and associated permissions when organization charts change. These updates, however, rely on organization chart input.

U.S. Pat. No. 6,564,264, entitled “System, Apparatus and Method for Automatic Address Updating of Outgoing And Incoming User Messages in a Communications Network”, describes automatically updating address information of a user's outgoing and incoming messages to/from a communication network. This patent relieves the user of having to manually enter address changes into a user address book when address changes are detected.

U.S. Pat. No. 6,189,026, entitled “Technique for Dynamically Generating an Address Book in a Distributed Electronic Mail System”, describes creating a full-text index for all stored messages, generating address-book mail messages, and realizing a dynamic address book by querying the full-text index for address-book information.

U.S. patent application No. 2002/0133557A1, entitled “Sorting E-mail”, describes placing arriving e-mail in one of four folders depending on whether the e-mail includes attachments and whether the sender is listed in a recipient's address book. This patent also describes blocking an e-mail in a particular category, with the blocked e-mail being either deleted or stored on the mail server for later downloading. Also, sorting is described based on whether the sender is categorized in the recipient's address book as a personal correspondent, a business correspondent, or a priority correspondent.

U.S. patent application No. 2003/0097361A1, entitled “Message Center Based Desktop Systems”, describes selecting and processing messages including data items, such as files, addresses, URLs, calendar events, and to-do items, for example, by sending reminder messages, storing address data in an address database, adding URLs to a bookmark file, or storing a file in a file-system folder.

U.S. patent application No. 2003/0195937A1, entitled “Intelligent Message Screening”, describes mail messages being analyzed according to user-defined criteria and assigned a numeric rank. Analysis may include determining the importance of the sender based on the sending address, the subject line, the message body, the recipient's address book, and a recipient profile. The recipient's address book is used not only to look for the sender's address, but also to look for nicknames, phone numbers, and company names appearing in the body of the message. The numeric rank is used to categorize the mail in terms of whether the recipient is likely to read, reply, save, and delete the message. Messages can be displayed by category and selected actions, such as displaying or deleting messages, and can be applied to all messages in a given category.

U.S. patent application No. 2002/0161782A1, entitled “Method for Automated Management of Received Messages”, describes classifying incoming mail according to a category, priority, and desired repeat-presentation time. Messages are stored in task folders corresponding to category and then redisplayed at the repeat-presentation time, with messages having the same repeat-presentation time displayed in priority order.

U.S. patent application No. 2003/0065728A1, entitled “Filing and Retrieval of E-Mail Into Person Associated Folders”, describes sets of names and keywords associated with folders. Incoming mail is placed in one or more folders based on names appearing in “From:”, “To:”, and “cc:” fields and keywords appearing in the “Subject:” field.

U.S. Pat. No. 6,216,122B1, entitled “Electronic Mail Indexing Folder Having Search Scope and Retrieval”, describes special folders called search folders, each of which, when triggered, searches received e-mail. A folder's search places a pointer to each message satisfying folder-specific criteria into that folder.

The prior art, including those referenced above, are limited in its uses, e.g., to organization chart input. A method is needed that can use any source of e-mail addresses and generate a variety of output.

### OBJECTS OF THE INVENTION

Accordingly, the present invention has been designed to solve the above and other problems occurring in the prior art, and it is an object of the present invention to provide a method of automatically generating valid lists of e-mail addresses.

It is another object of the present invention to provide a method of solving the problem of having to manually replicate address data that exists in e-mail documents for other uses, such as address books, mailing lists and instant messaging buddy lists.

It is yet another object of the present invention to provide a method of using any source of e-mail addresses to generate a variety of output, including mailing lists, access control lists, instant messaging buddy lists, and address book entries, while reflecting the organization of the e-mail address sources in the generated output.

It is still another object of the present invention to provide a method of manipulating address lists using set-theoretic operations.

### SUMMARY OF THE INVENTION

The present invention provides a method wherein address information from sender and recipient fields in e-mail documents is used to create entries in various types of address lists including, but not limited to, address books, mailing lists, access control lists and instant message buddy lists. Additionally, the present invention recognizes the organization of the e-mail documents, such as their arrangement in e-mail folders, and reflects that organization in its output. The present invention further describes comparison and updating of different collections of e-mail addresses.

A method for generating address lists from documents, which include e-mail addresses, stored on a computing device is provided. The method describes mapping at least one e-mail address from the documents to the address list. The mapped address list may be updated by its inclusion as one of the input documents. Duplicate entries can be excluded from the address list and an addressee identifier can be assigned to each e-mail address in the mapped address list, by using a mapping table, an address book, or a user assignment. Any user-specified organization of addresses existing in the input documents can be preserved in the mapped address list. The mapping of the e-mail addresses can be performed by applying one or more set-theoretic operations selected from one of union, intersection, and difference.

The input documents may be any combination of access control lists, mailing lists, address book entry lists, instant messaging buddy lists, e-mail documents, e-mail documents in a selection of e-mail folders, the results of a search predicate over a set of e-mail address sources, and one or more e-mail documents organized in one or more e-mail folders. The e-mail entries are selected from only one, different, any, or all of the sender address, recipient address, carbon copy address, and blind carbon copy address sections of the input documents. The address lists may be, but are not limited to, any of an access control list, mailing list, address book entry list, and instant messaging buddy list.

### BRIEF DESCRIPTION OF THE FIGURES

The foregoing and other objects, aspects, and advantages will be better understood from the following non-limiting detailed description of preferred embodiments of the invention with reference to the drawings that include the following:

FIG. 1a is a diagram showing the use of e-mail sender and recipient addresses to create address lists according to an embodiment of the present invention;

FIG. 1b is a diagram showing the use of sender and recipient addresses from multiple e-mails to create address lists according to an embodiment of the present invention;

FIG. 1c is a diagram showing the use of a mapping table to create an address list according to an embodiment of the present invention;

FIG. 1d is a diagram showing the use of e-mail sender and recipient addresses to update an address list according to an embodiment of the present invention;

FIG. 2a is a diagram showing the partition of a set of e-mail addresses into non-overlapping categories according to an embodiment of the present invention;

FIG. 2b is a diagram showing the placement of e-mail addresses into one or more potentially overlapping categories according to an embodiment of the present invention;

FIG. 2c is a diagram showing the partition of the set of e-mail addresses into a hierarchy of categories according to an embodiment of the present invention;

FIG. 2d is a diagram showing the partition of the set of e-mail addresses into non-hierarchical categories according to an embodiment of the present invention;

FIG. 3a is a diagram showing the construction of a set of e-mail addresses by applying set theoretic operations according to an embodiment of the present invention;

FIG. 3b is a diagram showing an example of determining whether all recipients of an e-mail message are members of a mailing list according to an embodiment of the present invention; and

FIG. 3c shows an example of augmenting a mailing list with the recipients of a collection of e-mail messages according to an embodiment of the present invention.

### DETAILED DESCRIPTION OF THE INVENTION

Preferred embodiments of the present invention will be described in detail herein below with reference to the accompanying drawings. In the following description of the present invention, a detailed description of known functions and configuration incorporated herein will be omitted when it may obscure the subject matter of the present invention.

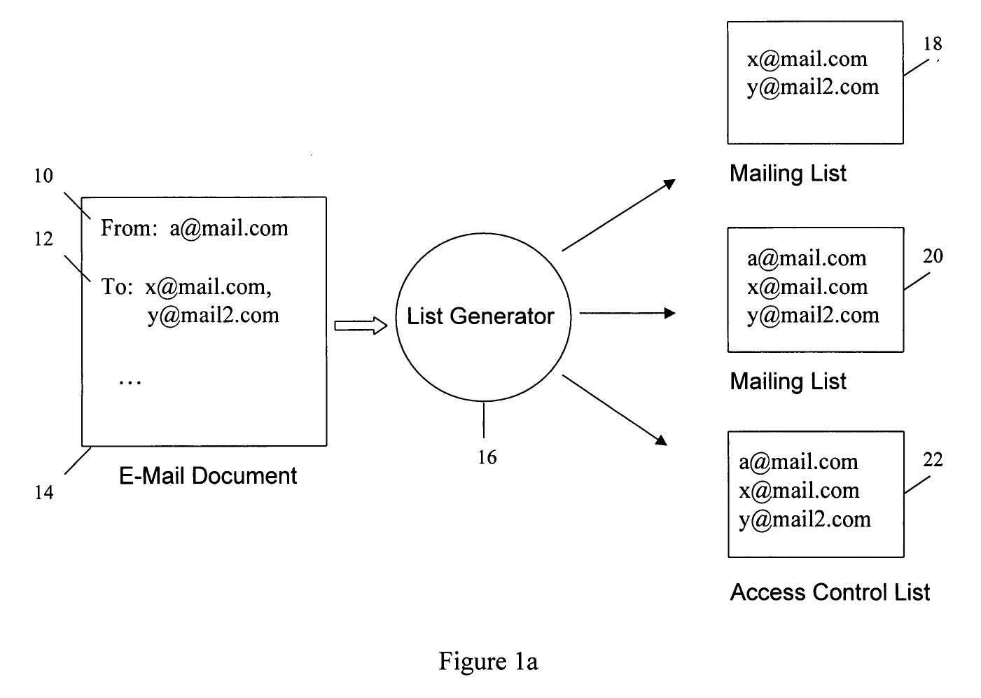

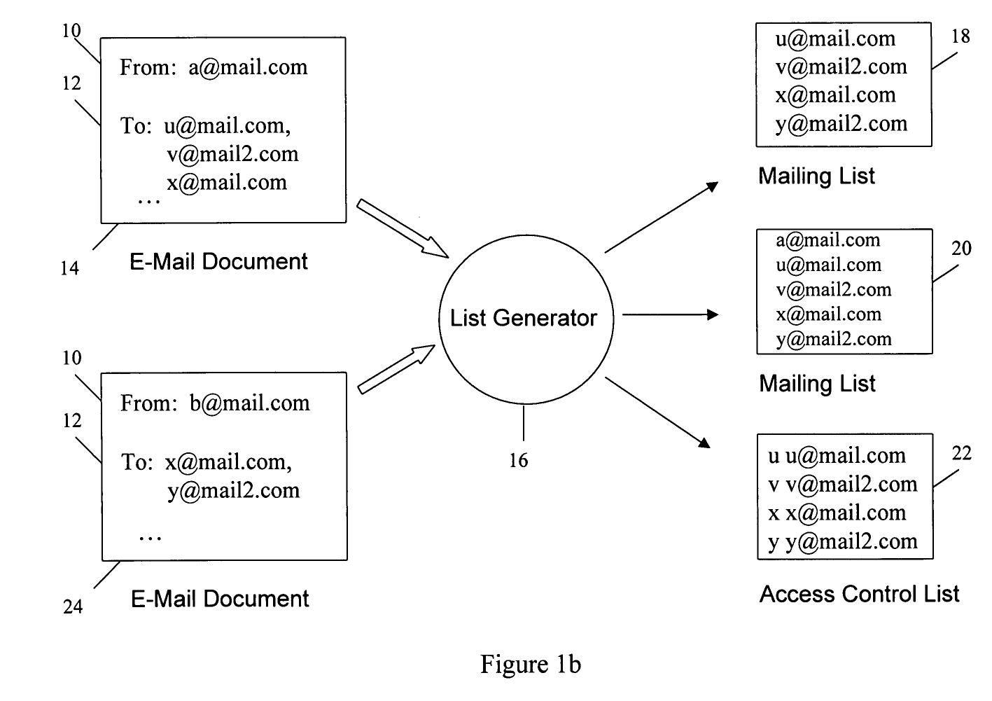

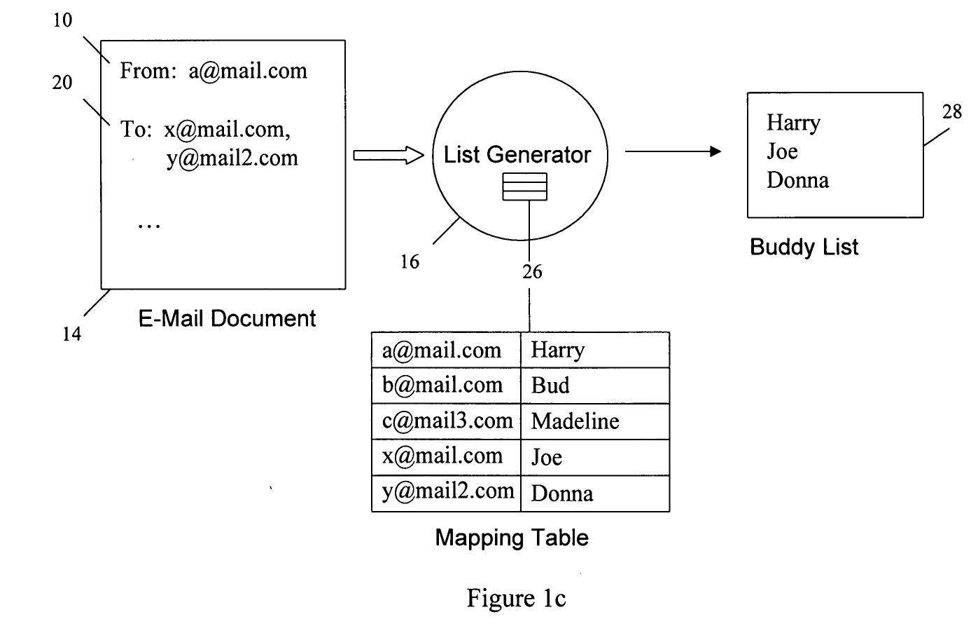

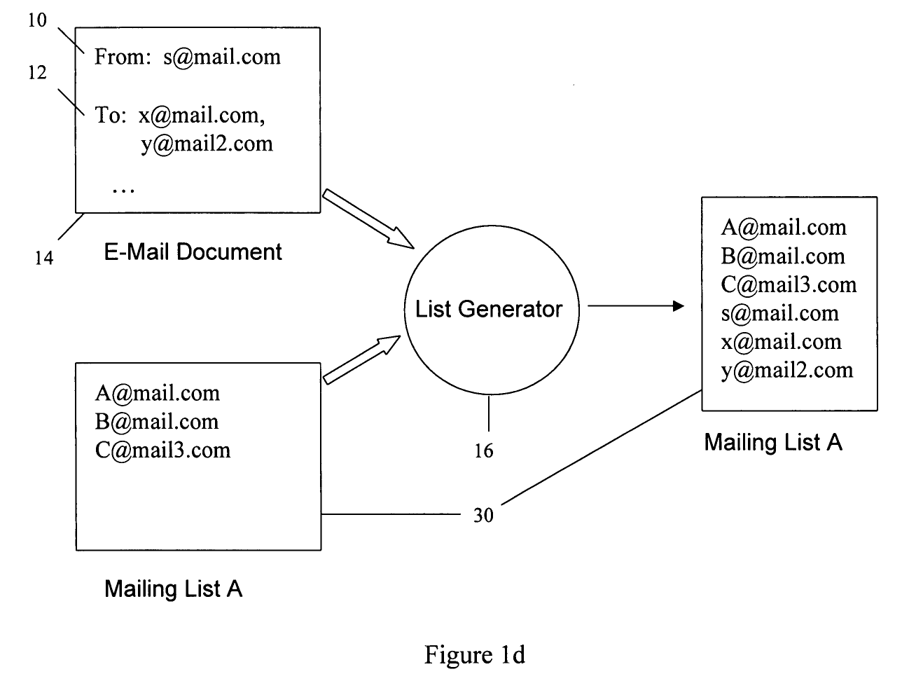

FIG. 1a illustrates the use of e-mail sender and recipient addresses to create address lists. An e-mail document 14 includes e-mail address information in a sender section 10 and in a recipient section 12. The e-mail document 14 is processed by a list generator 16, which formats and outputs various types of address lists. The list generator 16 can be implemented as multiple modules even though it is shown as one logical component. In general, the list generator 16 can output any number or type of address lists. Presently, two mailing lists and one access control list are illustrated. Mailing list 18 is generated using only recipient address information from the recipient section 12 of the e-mail document 14, and mailing list 20 is generated using sender and the recipient address information from the sender and the recipient sections 10 and 12 of the e-mail document 14. An access control list 22 is also generated using the sender and recipient address information from the sender and the recipient sections 10 and 12 of the e-mail document 14.

The list generator 16 may be programmed using commonly available computer languages, and executed for performance of the inventive method on commonly used computing devices, including personal computers (PC), cell phones, personal digital assistants (PDA), etc. The implementation of the list generator 16 will be obvious to those skilled in the art. It is easy to see that address lists 18, 20, and 22 may be created according to user-defined rules or according to user input or selection during runtime of the list generator 16.

FIG. 1b illustrates the use of the sender and recipient addresses from multiple e-mails to create address lists. E-mail documents 14 and 24 include e-mail address information in their respective sender and recipient sections 10 and 12. As described with reference to FIG. 1a, e-mail documents 14 and 24 are processed by the list generator 16, which can format and output various types of address lists. The list generator 16 outputs two mailing lists 18 and 20 and one access control list 22. The mailing list 18 is generated using only the recipient address information 12 from the e-mail documents 14 and 24. Mailing List 20 is generated using the sender and recipient address information 10 and 12 from the e-mail document 14 and recipient address information 12 from the e-mail document 24. The access control list 22 is generated using only the recipient address information 12 from the e-mail documents 14 and 24.

It is noted that the list generator 16 does not output duplicate entries. The e-mail address, x@mail.com, for example, appears in both e-mail documents 14 and 24, but only one entry for that address is added to the address lists 18, 20, and 22. In general, the list generator 16 can implement any appropriate policy concerning duplicate input addresses. Filtering out duplicate entries is a commonly used technique, known to those skilled in the art.

Further, in the present invention, the list generator 16 can accept any number of e-mail documents 14 and 24 as input and produce any number of output address lists 18, 20, and 22. It is appreciated that the number of input documents and output lists is limited by the storage capacity of the computing device on which the present invention is implemented. However, when such computing device is connected to the Internet, the storage capacity can be supplemented by storage devices distributed on the Internet and can therefore be significantly increased.

FIG. 1c illustrates the use of a mapping table to create an address list. The e-mail document 14 includes the e-mail address information in the sender section 10 and in the recipient section 12. The list generator 16 has access to a mapping table 26 that allows the list generator 16 to map input addresses to output address list entries. The mapping table 26 includes e-mail addresses in the left column and their associated instant message screen names in the right column. A generated buddy list 28 includes entries that were mapped from the sender and recipient e-mail address 10 and 12 in the e-mail document 14 using the mapping table 26. In general, the list generator 16 can perform mapping, formatting, or translation of any type of e-mail addresses as it generates new address list entries. For example, in one preferred embodiment of the present invention, the list generator 16 can map Internet e-mail addresses to proprietary e-mail addresses, such as Lotus Notes addresses, during a list generation.

FIG. 1d illustrates the use of the list generator 16 to update an address list 30 with e-mail sender and recipient addresses 10 and 12. The e-mail document 14 includes the e-mail address information in the sender section 10 and in the recipient section 12. Mailing list A 30 is shown as both the input to and the output of the list generator 16. E-mail addresses from the e-mail document 30 are added to those that presently exist in the mailing list A 30 before generation occurs. Any address duplication problems can be resolved in the same manner as that described with reference to FIGS. 1a and 1b.

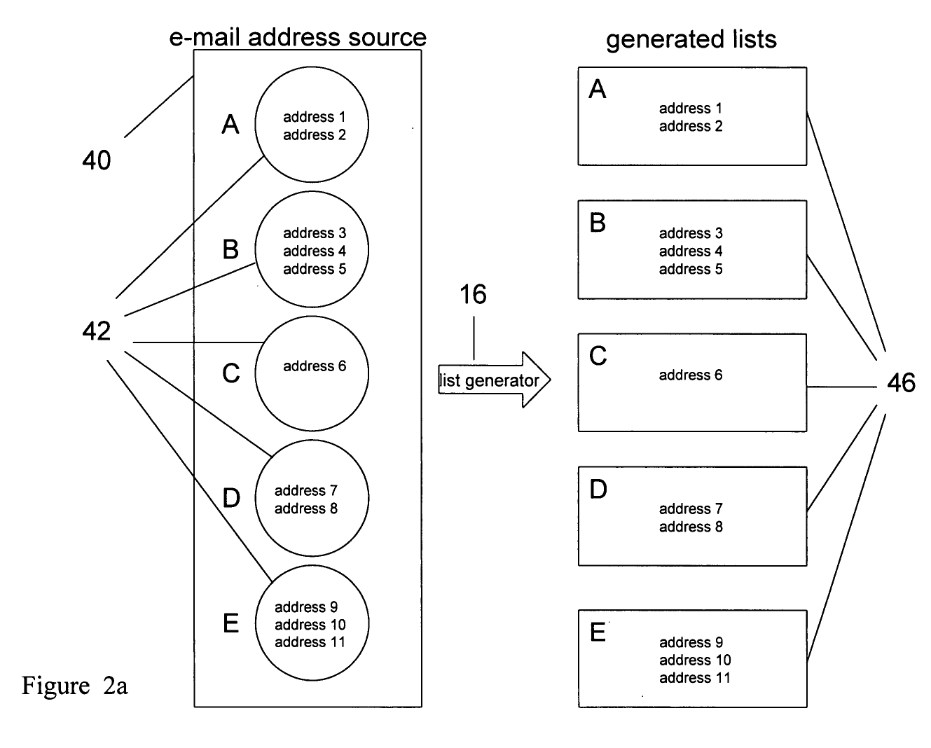

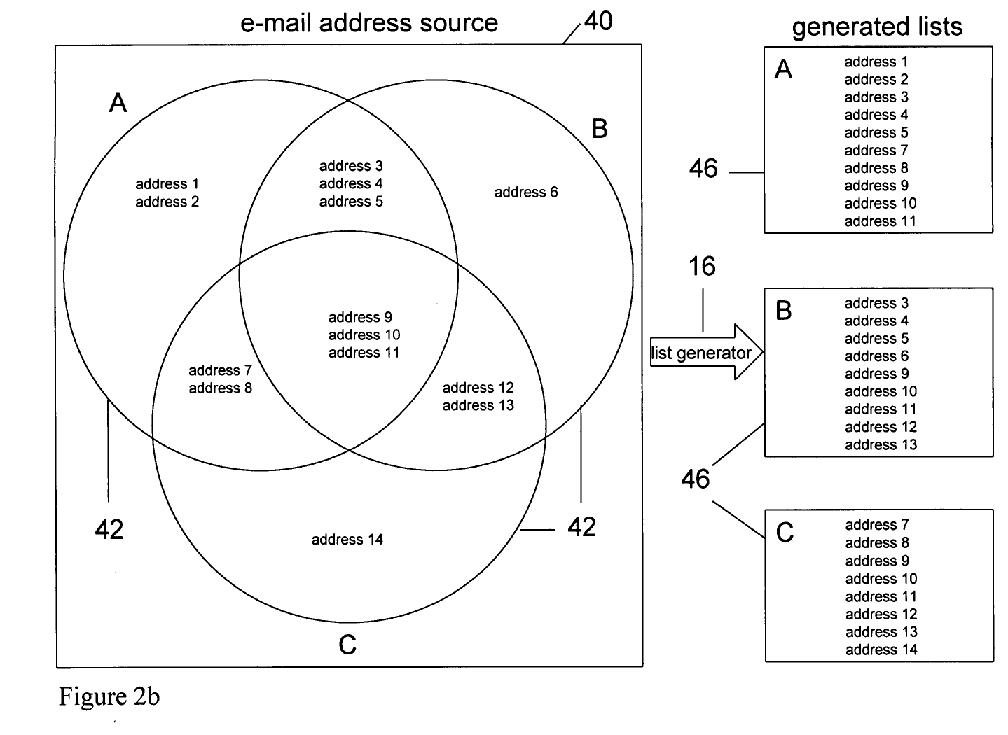

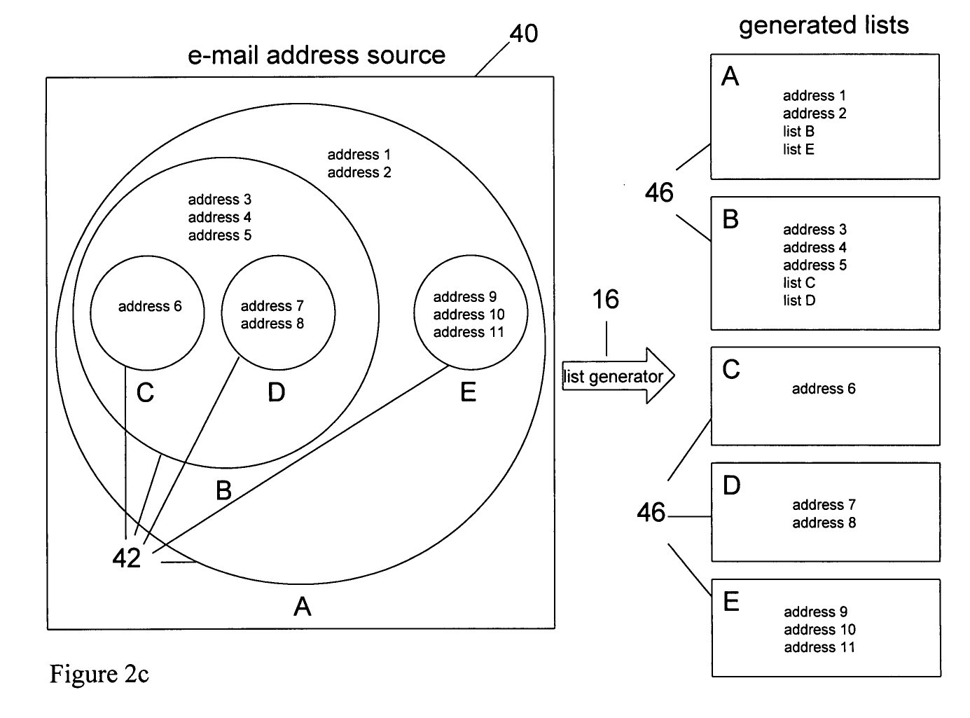

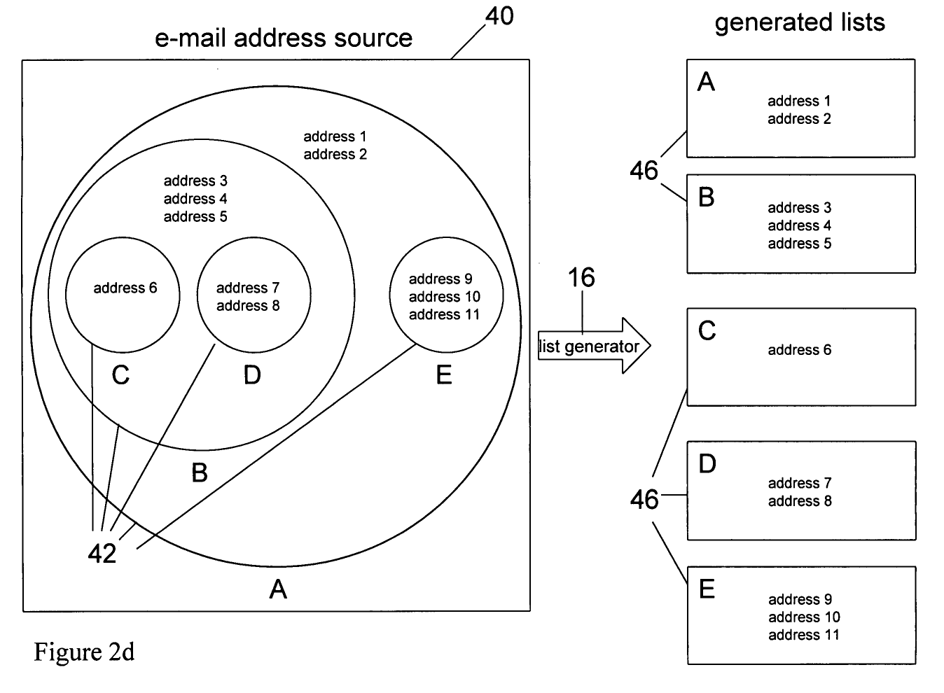

In another aspect of the present invention, address lists reflecting organization of sources of e-mail addresses having user-specified organization are generated. In other words, list generator 16 preserves the organization of the sources of the e-mail addresses in the output address lists. This preservation is achieved in a number of ways described below with reference to FIGS. 2a-2d.

FIG. 2a illustrates a source of e-mail addresses 40 in which the user-specified organization includes a partition of a set of e-mail addresses into non-overlapping categories 42. A list generator 16 generates address lists 46 that reflect this organization corresponding to each category, including the e-mail addresses in that category.

FIG. 2b illustrates the source of e-mail addresses 40 in which the user-specified organization includes the placement of each e-mail address into the one or more potentially overlapping categories 42. The list generator 16 generates address lists 46 that reflect this organization corresponding to each category including the e-mail addresses in that category, with any given address potentially appearing in one or more address lists.

The source of e-mail addresses 40 may be a filter that is applied to the e-mail addresses supplied by a plurality of e-mail addresses sources. The filter can apply a predicate to each of these e-mail addresses supplied by a source, creating a set of e-mail addresses for which the predicate is true.

FIG. 2c illustrates the source of e-mail addresses 40 in which the user-specified organization includes the partition of the set of e-mail addresses into a hierarchy of categories 42, some of which are subordinate to others. The depiction of one category nested within another indicates that the inner category is subordinate to the outer category. The address lists 46 generated by the list generator 16 reflect this organization through the generation of a hierarchy of address lists that are isomorphic to the hierarchy of categories, with each generated address list 46 including the e-mail addresses in the corresponding category. In a preferred embodiment, the hierarchy of the generated address lists is realized by a set of address lists 46 each potentially containing not only e-mail addresses, but also references to directly subordinate address lists, for example an address list 46 B includes a reference to subordinate address lists 46 C and 46 D, which reflect categories 42 C and 42 D.

FIG. 2d illustrates the source of e-mail addresses 40 in which the user-specified organization includes the partition of the set of e-mail addresses into a hierarchy of categories 42, as described with reference to FIG. 2c, where the list generator 16 generates a set of address lists 46 reflecting the category of each e-mail address, but ignores the hierarchical relationship of the categories 42. Alternatively, the set of hierarchical categories 42 may be regarded as overlapping, so that all e-mail addresses included in a category 42, directly or indirectly subordinate to a category X, are also considered to belong to the category X. Here, the hierarchy of categories 42 is treated as a set of overlapping categories, the same as described with reference to FIG. 2b.

Referring to FIGS. 2a-2d, the source of the e-mail addresses 40 may be selected from
1. A set of mailing lists, where a user-specified organization may include:
   a. the placement of particular e-mail addresses within particular address lists, and
   b. hierarchy specified by the inclusion within one mailing list of a reference to a subordinate mailing list.
2. A set of access-control lists, where a user-specified organization may include:
   a. the placement of particular e-mail addresses within particular address lists; and
   b. the partition of an access-control list into sub-lists such that all e-mail addresses within the same sub-list have the same access rights.
3. An instant-messaging buddy list, where if unique identifiers for instant-messaging users are not the e-mail addresses of those users, there may be a mapping from instant-messaging user identifiers to e-mail addresses, and a user-specified organization may include:
   a. the assignment of an instant-messaging user identifier to a particular group.
4. A set of e-mail documents stored in folders, where a single e-mail document may be stored in multiple folders, and a user-specified organization may include:
   a. the placement of particular e-mail addresses within particular folders; and
   b. hierarchy specified by the inclusion within one folder of a subordinate folder.

Generated address lists 46 may be selected from mailing lists, access-control lists, instant-messaging buddy lists, etc. If unique identifiers for instant-messaging users are not the e-mail addresses of those users, there may be a mapping from e-mail addresses to instant-messaging user identifiers.

In addition, the present invention anticipates other kinds of sources of e-mail addresses and other forms of user-specified organization.

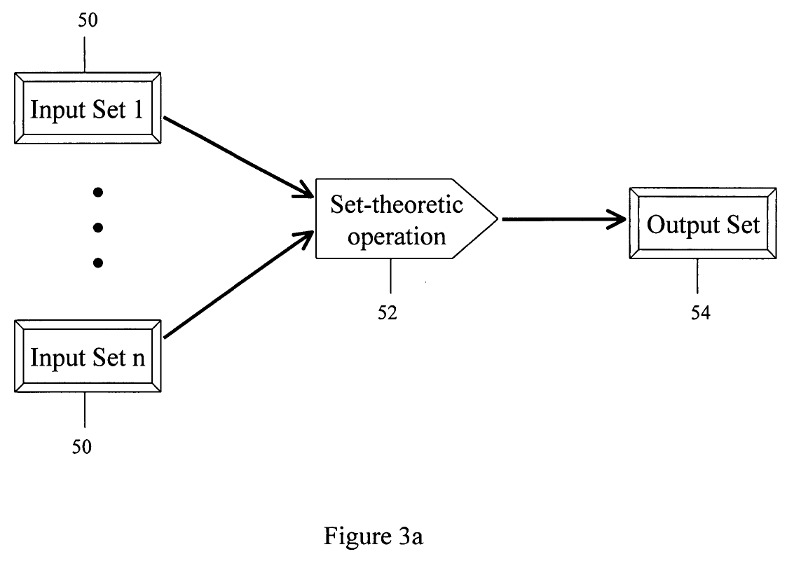

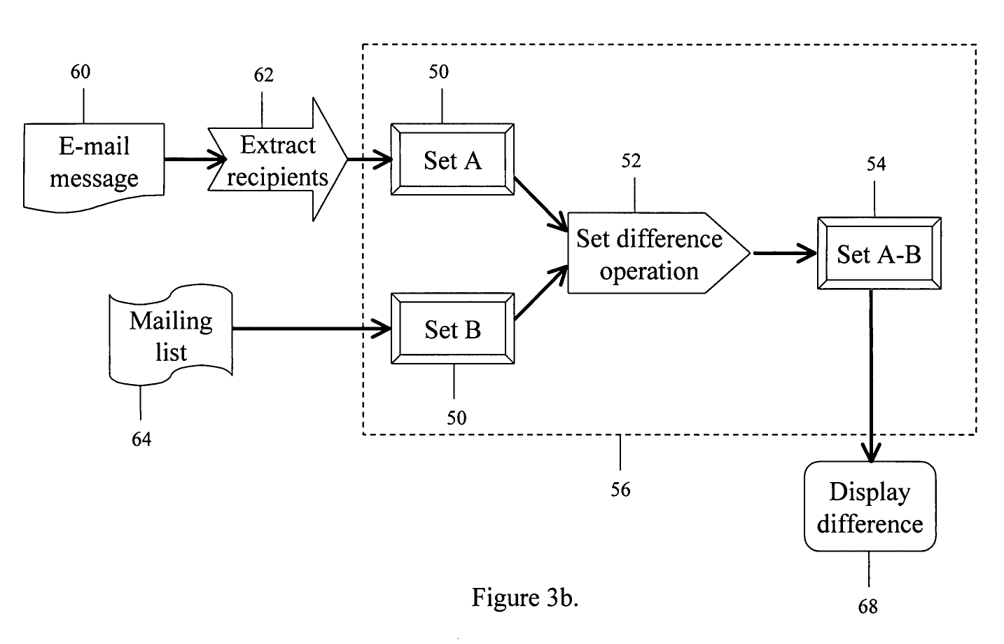

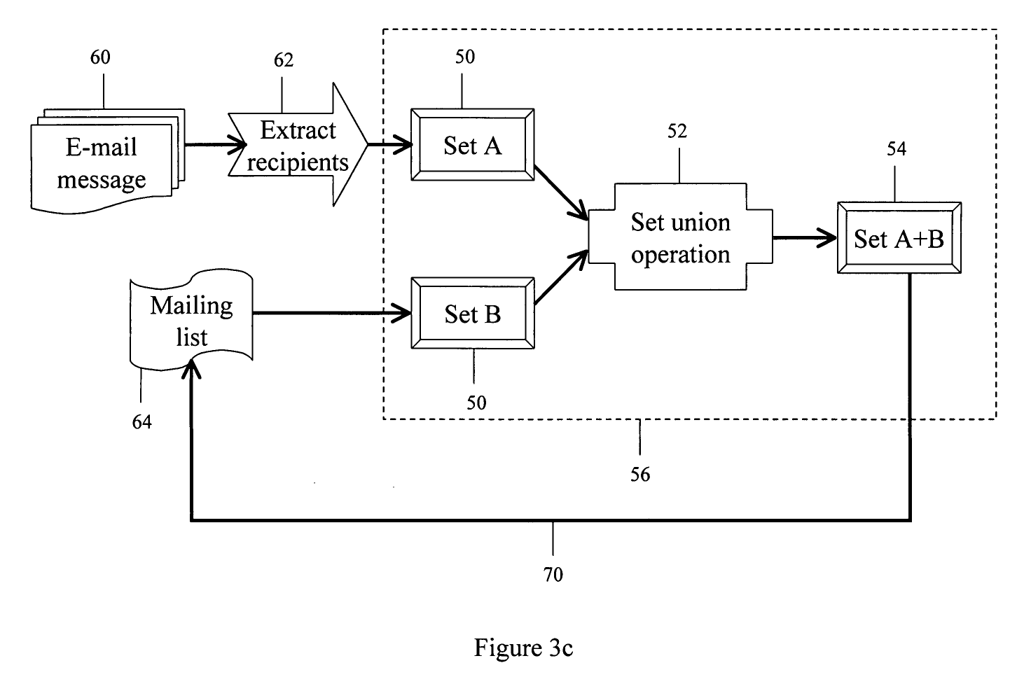

FIG. 3a illustrates a method for constructing a set of e-mail addresses by applying set-theoretic operations 52, such as union, intersection, and difference, on two or more input sets 50 of e-mail addresses. Two or more sets of e-mail addresses 50 are used as inputs to a set-theoretic operation process 52. The result of the applying the set-theoretic operation process 52 is an output set of e-mail addresses 54. The input sets 50 may be obtained from a variety of sources, including e-mail addresses included in a selection of e-mail documents, mailing lists, access control lists, instant messaging buddy lists, and others. For example, there may be five input sets 50 on which a union operation is computed, so that the output set 54 includes all e-mail addresses that appear in one or more of the five input sets.

FIG. 3b illustrates how the method described with reference to FIG. 3a can be used to determine whether all recipients of an e-mail message are members of a mailing list. An e-mail message 60 is provided as an input to a process 62 that extracts a set, denoted as Set A, of recipient input sets of e-mail addresses 50 from the e-mail message 60. A mailing list 64 is represented as a set, denoted as Set B, of e-mail addresses 50 included in the mailing list 64. Sets A and B 50 are used as inputs to the set-theoretic operation process 52, here a set difference operation, which computes a set of e-mail addresses contained in Set A 50 but not contained in Set B 50. The resulting Set A-B 54 can be then displayed 68 to a user of an e-mail system for informational purposes, or used by some other automated process.

FIG. 3c illustrates how the method described with reference to FIG. 3a can be used to augment a mailing list with the recipients of a collection of e-mail messages. Collections of e-mail messages 60 are provided as an input to the process 62 that extracts from them the set, denoted as Set A, of recipient e-mail addresses 50. The mailing list 64 is represented as a set, denoted as Set B, of e-mail addresses 50 included in the mailing list 64. Sets A and B 50 are used as inputs to the set-theoretic operation process 52, here a set union operation, which computes the set of e-mail addresses contained in Set A, Set B or both. The resulting Set A+B 54 is, as depicted by line 70, entered back, replacing the original content, into the input mailing list 64.

While the present invention has been shown and described with reference to certain preferred embodiments thereof, it will be understood by those skilled in the art that various changes in form and details may be made therein without departing from the spirit and scope of the present invention as defined by the appended claims.

We claim:

1. A method for generating at least one address list from one or more documents located in at least one storage section of at least one computing device, the documents having one or more sections, each section including at least one e-mail address, the method comprising the steps of:
mapping at least one e-mail address from the one or more documents to the at least one address list, which includes an access control list and a mailing list.

2. The method of claim 1, further comprising a step of updating the at least one mapped address list, wherein said at least one mapped address list is included in the one or more documents.

3. The method of claim 1, wherein said one or more sections are selected from one of a sender address, recipient address, carbon copy address, and blind carbon copy address.

4. The method of claim 3, wherein the mapped e-mail addresses are selected from only one section of the one or more sections.

5. The method of claim 3, wherein the mapped e-mail addresses are selected from any of the one or more sections.

6. The method of claim 3, wherein the mapped e-mail addresses are selected from a different section of the one or more sections of each of the one or more documents.

7. The method of claim 1, further comprising a step of excluding duplicate entries from the at least one address list.

8. The method of claim 1, further comprising a step of assigning an addressee identifier to each of the at least one e-mail address in the at least one address list, wherein said addressee identifier is selected from one of a mapping table and a user assignment.

9. A method for generating at least one address list from documents located in at least one storage section of at least one computing device, the documents having one or more sections, each section including at least one e-mail address, the method comprising the steps of:
mapping at least one e-mail address from the documents to the at least one address list, which includes at least one of an access control list, a mailing list, an address book entry list, and an instant messaging buddy list; and
preserving a user-specified organization of addresses in the documents in each mapped address list, wherein said user-specified organization of addresses existed among the documents prior to the mapping step.

10. The method of claim 9, further comprising a step of updating the each mapped address list, wherein each mapped address list is included in at least one of the documents.

11. The method of claim 9, wherein the documents are selected from one of access control lists, mailing lists, address book entry lists, e-mail documents organized in e-mail folders, and instant messaging buddy lists.

12. The method of claim 11, wherein said user-specified organization is selected from one of a selection of email folders, exclusive and inclusive set intersections of e-mail addresses of one or more groups of e-mail folders, and a search predicate over a set of e-mail address sources.

13. A method for forming a new set of one or more e-mail addresses in at least one storage section of at least one computing device, the method comprising the steps of:
applying set-theoretic operations on a plurality of existing sets of e-mail addresses, said operations being selected from known set operators.

14. The method of claim 13, wherein said operations being selected from one of union, intersection, and difference.

15. The method of claim 13, wherein the plurality of sets are selected from one of access control lists, mailing lists, address book entry lists, instant messaging buddy lists, e-mail documents, the results of a search predicate over a set of e-mail address sources, and one or more e-mail documents organized in one or more e-mail folders.

16. The method of claim 13, wherein the new set replaces one of the operands of said set-theoretic operation.

17. A computer program device readable by a machine, tangibly embodying a program of instructions executable by the machine to perform method steps for generating at least one address list from one or more documents located in at least one storage section of at least one computing device, the documents having one or more sections, each section including at least one e-mail address, the method comprising the steps of:
mapping at least one e-mail address from the one or more documents to the at least one address list, which includes an access control list and a mailing list.

18. A computer program device readable by a machine, tangibly embodying a program of instructions executable by the machine to perform method steps for generating at least one address list from one or more documents located in at least one storage section of at least one computing device, the documents having one or more sections, each section including at least one e-mail address, the method comprising the steps of:
mapping at least one e-mail address from the one or more documents to the at least one address list, which includes at least one of an access control list, a mailing list, an address book entry list, and an instant messaging buddy list; and
preserving a user-specified organization of addresses in the one or more documents in the mapped at least one address list, wherein said user-specified organization of addresses existed among the one or more documents prior to the mapping step.
